(19) United States
(12) Patent Application Publication
(10) Pub. No.: US 2013/0215032 A1
(43) Pub. Date: Aug. 22, 2013

(54) ELECTRONIC DEVICE INCLUDING TWO DISPLAY UNITS AND SWITCHING DISPLAY METHOD USING SAME

(71) Applicant: Fitipower Integrated Technology, Inc., (US)

(72) Inventors: CHEN-CHI YANG, Hsinchu (TW); KE-MING SU, Hsinchu (TW)

(73) Assignee: FITIPOWER INTEGRATED TECHNOLOGY, INC., Hsinchu City (TW)

(21) Appl. No.: 13/726,122

(22) Filed: Dec. 23, 2012

(30) Foreign Application Priority Data
Feb. 22, 2012 (TW) 101105725

(51) Int. Cl. G06F 3/14; G06F 3/01

(52) U.S. Cl. CPC G06F 3/1423; G06F 3/01
USPC 345/163; 345/156

(57) ABSTRACT

An electronic device includes a display device, an operating unit, and a processing unit. The display device includes a first display unit having a plurality of first pixels for displaying moving images, and a second display unit having a plurality of second pixels for displaying still images. The first pixels and the second pixels are alternately arranged. The operating unit can be used to select an area of the display device. The processing unit defines the selected area to be a primary display area and defines a region of the display device excluding the selected area to be an auxiliary display area. The processing unit controls the first display unit to display data in the primary display area and controls the second display unit to display data in the auxiliary display area. The present disclosure also provides a switching display method using the electronic device.

### TECHNICAL FIELD

Embodiments of the present disclosure relate to an electronic device including two display units and a switching display method using the same.

### DESCRIPTION OF RELATED ART

Displays such as LCD displays and e-ink displays are commonplace. Although LCD displays have fast response speed and are suited for displaying moving images, the power consumption of LCD displays is substantially high. On the other hand, e-ink displays are less power hungry but the e-ink displays have slow response speed and are only suitable for displaying still image.

Thus, a need exists to overcome the above-described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of an electronic device of one embodiment of present disclosure, the electronic device including a display device.

FIG. 2 is a top view of the display device of FIG. 1, the display device displaying a plurality of display interfaces thereon.

FIG. 3 is a top view of the display device of FIG. 1, the display device displaying a selected frame thereon.

FIG. 4 is a flowchart of one embodiment showing a switching display method of the electronic device of FIG. 1.

FIG. 5 is a flowchart of other one embodiment showing a switching display method of the electronic device of FIG. 1.

FIG. 6 is a top view of the display device of FIG. 1, the display device including a first display and a second display.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include compact discs (CDs), digital video discs (DVDs), BLU-RAY disks, Flash memory, and hard disk drives.

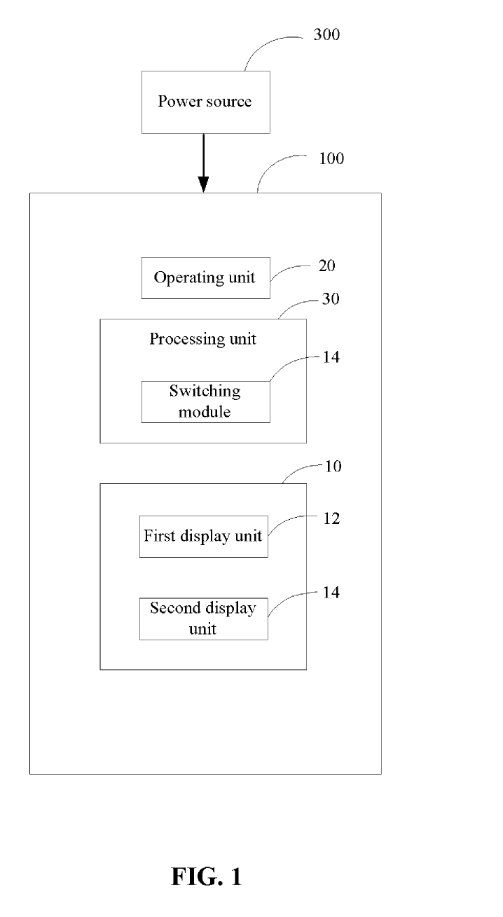

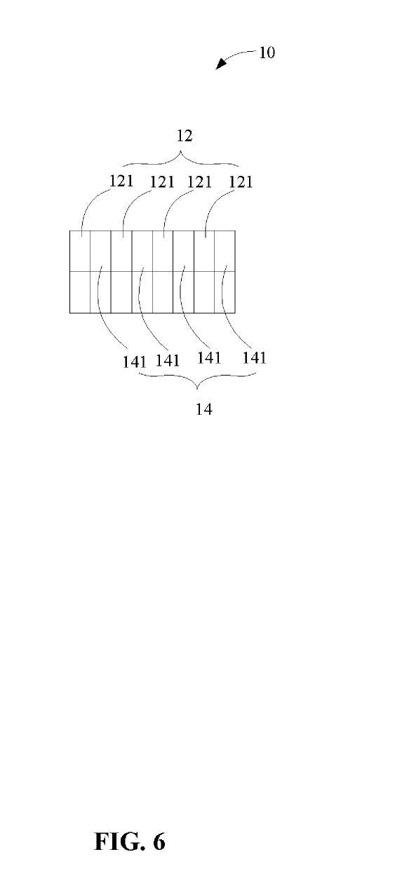

Referring to FIG. 1, an electronic device 100 of one embodiment of present disclosure is shown. The electronic device 100 includes a display device 10, an operating unit 20, and a processing unit 30. The display device 10 includes a first display unit 12 and a second display unit 14 physically distinct and independent of each other. As shown in FIG. 6, the first display unit 12 includes a plurality of first pixels 121. The second display unit 14 includes a plurality of second pixels 141. The first display unit 12 and the second display unit 14 overlap and the first pixels 121 and the second pixels 141 are alternately arranged as shown in FIG. 6. In one embodiment, the first display unit 12 is a liquid crystal display or an organic light emitting diode display and suited for displaying moving images. The second display 14 is an e-ink display and suited for displaying still images.

The operating unit 20 selects a display area on the display device 10 according to operations of a user. The selected display area of the display device 10 is defined as a primary display area. A region of the display device 10 excluding the selected display area is defined as an auxiliary display area. In this embodiment, the operation unit 20 can be a touch screen or a mouse.

The processing unit 30 includes a switching module 31 which is configured to control the operation of the display device 10. In one embodiment, the switching module 31 is executed in the first processor 30 for switching between the operations of the first and the second display unit 12 and 14.

In detail, the switching module 31 of the processing unit 30 controls one of the first display unit 12 and the second display unit 14 of the display device 10 to display data in the primary display area, and controls the other one of the first display unit 12 and the second display unit 14 to display data in the auxiliary display area. In one embodiment, the processing unit 30 may be a processor having memory thereof.

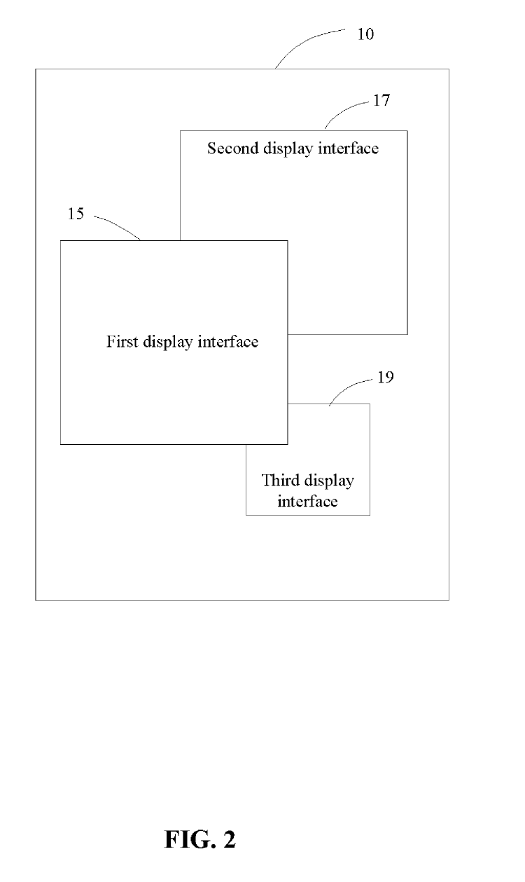

Referring FIG. 2, in one embodiment, the display device 10 displays a plurality of display interfaces thereon. In one embodiment, the plurality of display interfaces includes a first display interface 15, a second display interface 17, and a third display interface 19. When the user selects or activates one of the plurality of display interfaces using the operating unit 20, for example the first display interface 15, the selected display interface 15 is defined to be the primary display area by the switching module 31 and the display of the primary display area is made by the first display unit 12. The second and the third display interfaces 17 and 19 which are not selected or activated by the user are defined to be the auxiliary display area by the switching module 31 and the display of the auxiliary display area is made by the second display unit 14. Alternatively, the second display unit 14 will create any display on the auxiliary display area.

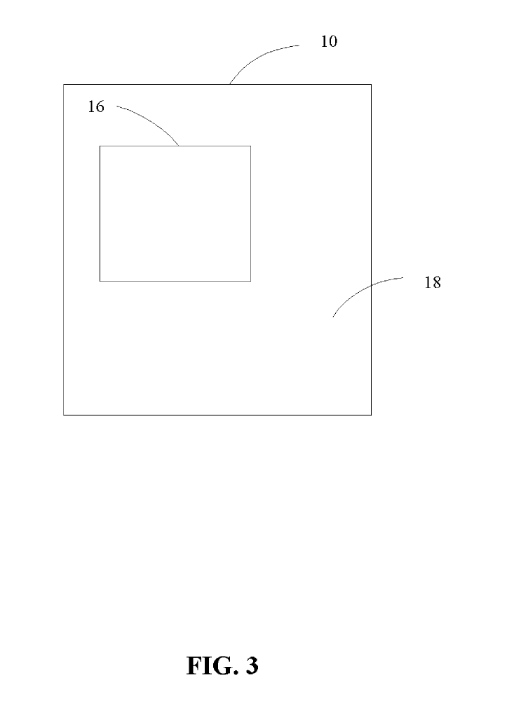

Referring FIG. 3, in an alternative embodiment, the user may use the operating unit 20 to directly select a frame area 16, for example, using a mouse to draw a square frame area 16. In this embodiment, the selected frame area 16 is defined as the primary display area by the switching module 31. A region of the display device 10 excluding the frame area 16 is defined as the auxiliary display area by the switching module 31. The processing unit 30 controls one of the first display unit 12 and the second display unit 14 to display images in the primary display area, and controls the other one of the first display unit 12 and the second display unit 14 to display images in the auxiliary display area.

The power source 300 provides an operating voltage to the electronic device 100. The switching module 31 of processing unit 30 compares the operating voltage with a first predetermined value, when the operating voltage from the power source 300 is less than the first predetermined value, the processing unit 30 controls the first display unit 12 to stop displaying any images. At the same time, the processing unit 30 controls the second display unit 14 to display images in the primary display area and the auxiliary display area.

In one alternative embodiment, the processing unit 30 pre-defines a second predetermined value. After the processing unit compares the operating voltage with the first predetermined value the processing unit 30 further compares a first image with a previous second image displayed on the display device 10. If the first image has an image change value greater than the second predetermined value, the processing unit 30 determines the first image to be a moving image and controls the first display unit 12 to display the first image. On the other hand, if the first image has an image change value less than the second predetermined value, the processing unit 30 determines the first image to be a still image, and controls the second display unit 14 to display the first image. When the switching module 31 of the processing unit 30 determines that the operating voltage from the power source 300 is less than the first predetermined value, the processing unit 30 increases the second predetermined value so as to increase number of still images to be defined, thereby to use the second display unit 14 more frequently for saving power.

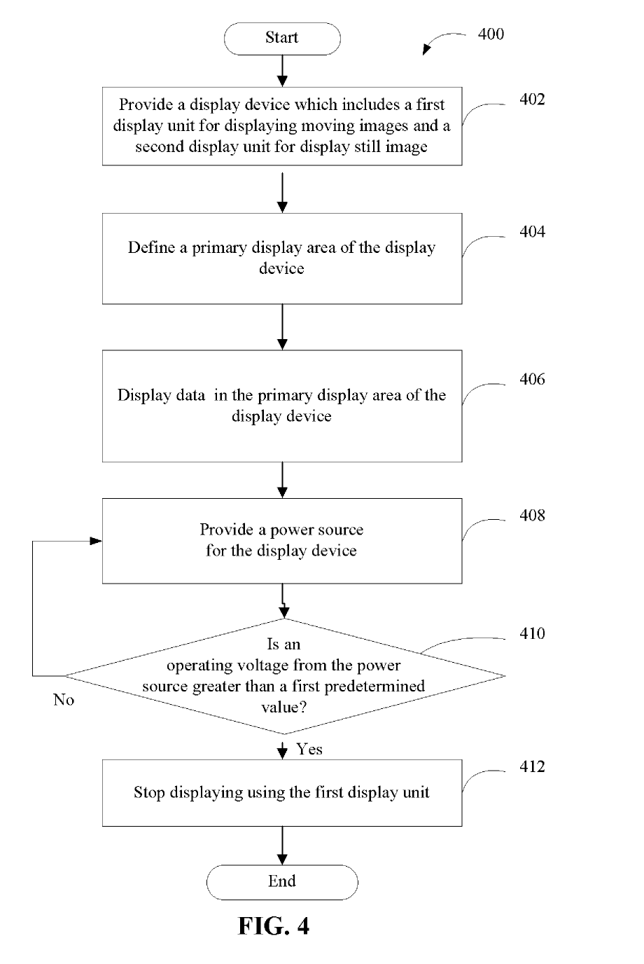

FIG. 4 is a flowchart of one embodiment showing a switching display method.

The method is carried out using the electronic device 100. Depending on the embodiment, additional steps may be added, others removed, and the ordering of the steps may be changed.

In step 402, the electronic device 100 including a display device 10 is provided. The display device includes a first display unit 12 for displaying moving images and a second display unit 14 for displaying still images. In this embodiment, the first display unit 12 includes a plurality of first pixels 121 and the second display unit 14 includes a plurality of second pixels 141 as shown in FIG. 6. The first pixels 121 and the second pixels 141 are alternately arranged in an observed angle to the display device 10.

In step 404, a user uses the operating unit 20 to select an area on the display device 10. A switching module 31 defines the selected area of the display device 10 to be a primary display area. The switching module 31 also defines a region which excludes the selected area of the display device 10 to be an auxiliary display area. The primary display area and the auxiliary display area are defined as above.

In step 406, a power supply 300 provides an operating voltage to the electronic device 100 to make the electronic device 100 work.

In step 408, a processing unit 30 controls the first display unit 12 to display moving images in the primary display area, and controls the second display unit 14 to display still images in the auxiliary display area.

In step 410, the processing unit 30 compares the operating voltage of a power source 300 and determines if the operating voltage of the power source 300 is less than a first predetermined voltage. If the operating voltage of the power source 300 is less than a first predetermined value, step 412 is performed, if not the procedure goes back to step 406.

In step 412, the processing unit 30 controls the first display unit 12 to stop any display. At the same time, the processing unit 30 controls the second display unit 14 to display data in the primary display area and the auxiliary display area.

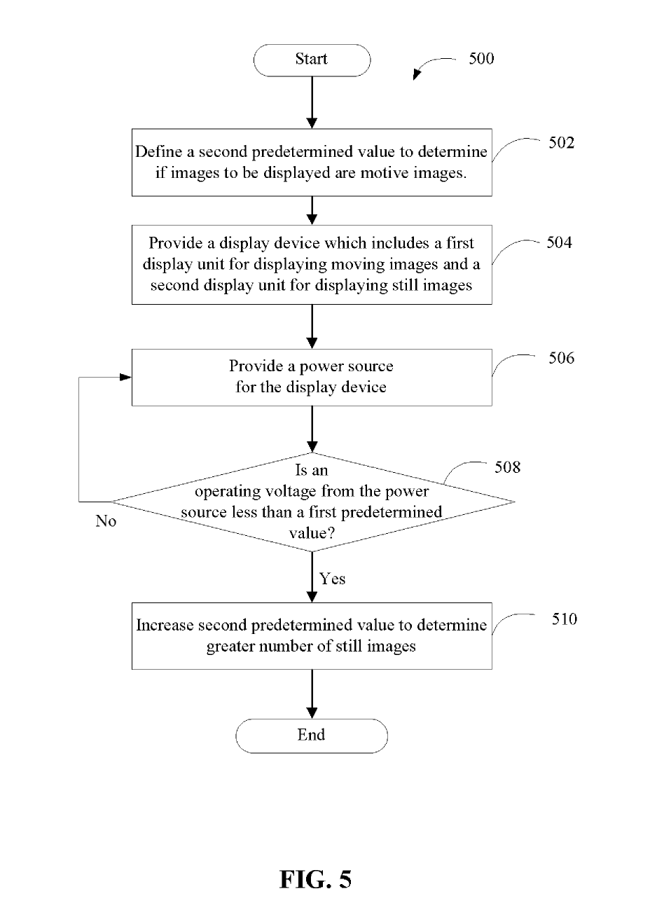

FIG. 5 is a flowchart of an alternative embodiment showing another switching display method. The method is carried out using the electronic device 100. Depending on the embodiment, additional steps may be added, others removed, and the ordering of the steps may be changed.

In step 502, an electronic device 100 including a display device 10 is provided. The display device 10 includes a first display unit 12 for displaying moving images and a second display unit 14 for displaying still images. In this embodiment, the first display unit 12 includes a plurality of first pixels 121 and the second display unit 14 includes a plurality of second pixels 141. The first pixels 121 and the second pixels 141 are alternately arranged in an observed angle to the display device 10.

In step 504, a power source 300 provides an operating voltage to the electronic device 100 to make the electronic device 100 work.

In step 506, a first predetermined value is defined according to the operating voltage to determine if the operating voltage is lower enough. A second predetermined value is defined and provided by a user to determine the level of image change values which is required for images to be displayed as moving images.

In step 508, a processing unit 30 compares the operating voltage of a power source 300, and determines if the operating voltage is more or less than a first predetermined value. If the operating voltage is less than a first predetermined value, step 510 is performed, if not the procedure goes back to step 504.

In step 510, the processing unit 30 increases the second predetermined value so as to enlarge the definition of still images when switching module 31 of the processing unit 30 compares that the operating voltage from the power source 300 is less than the first predetermined value, thereby using the second display unit 14 more frequently to save power.

In an alternative embodiment, steps 502-510 may be performed following step 408. In an alternative embodiment, steps 410-412 may be omitted.

Even though numerous characteristics and advantages of certain inventive embodiments have been set out in the foregoing description, together with details of the structures and functions of the embodiments, the disclosure is illustrative only; and changes may be made in detail, especially in the matter of arrangement of parts within the principles of present invention to the full extent indicated by the broad general meaning of the terms in which the appended claims are expressed.

What is claimed is:

1. An electronic device comprising:
a display device comprising a first display unit having a plurality of first pixels for displaying moving images, and a second display unit having a plurality of second pixels for displaying still images, the first pixels and the second pixels being alternately arranged,
an operating unit configured for selecting an area of the display device; and
a processing unit defining the selected area to be a primary display area and defining a region of the display device excluding the selected area to be an auxiliary display area, the processing unit controlling the first display unit to display data in the primary display area and controlling the second display unit to display data in the auxiliary display area.

2. The electronic device of claim 1, wherein the first display unit is a liquid crystal display or an organic light emitting diode display.

3. The electronic device of claim 1, wherein the second display unit is an e-ink display.

4. The electronic device of claim 1, wherein the operating unit comprises a touch screen or a mouse.

5. The electronic device of claim 1, wherein the processing unit comprises a switching module configured to control the operation of the display device.

6. The electronic device of claim 5, wherein the switching module comprises a plurality of programs in the form of one or more computerized instructions stored in an internal memory of the processor and executed by the processor.

7. The electronic device of claim 1, wherein the display device displays a plurality of display interfaces thereon, the processing unit defines one of the plurality of display interfaces selected by the operating unit to be the primary display area.

8. The electronic device of claim 7, wherein the processing unit defines the other of the plurality of display interfaces which are not selected by the operating unit to be the primary display area.

9. The electronic device of claim 1, wherein the selected area is square shaped.

10. The electronic device of claim 1, further comprising a power source configured for providing an operating voltage to the electronic device.

11. The electronic device of claim 10, wherein the processing unit controls the first display unit to stop displaying, when the operating voltage outputted from the power source is less than a first predetermined value.

12. The electronic device of claim 11, wherein the processing unit controls the second display unit to display images in the primary display area and the auxiliary display area, when the operating voltage output from the power source is less than the first predetermined value.

13. The electronic device of claim 12, wherein the processing unit defines a second predetermined value to determine if images to be displayed are moving images.

14. The electronic device of claim 13, wherein the processing unit increases the second predetermined value when the operating voltage outputted from the power source is less than the first predetermined value.

15. A switching display method comprising:
providing a display device, the display device comprising a first display unit having a plurality of first pixels for displaying moving images, and a second display unit having a plurality of second pixels for displaying still images, the first pixels and the second pixels being alternately arranged;
selecting an area of the display device by an operating unit;
defining the selected area to be a primary display area and defining a region of the display device excluding the selected area to be an auxiliary display area by a processing unit; and
controlling the first display unit to display data in the primary display area and controlling the second display unit to display data in the auxiliary display area by the processing unit.

16. The switching display method of claim 15, further comprising displaying a plurality of display interfaces on the display device, and the primary display area is defined by one of the plurality of display interfaces which is activated by the operating unit.

17. The switching display method of claim 16, wherein the auxiliary display area is defined by the other one of the plurality of display interfaces which is not activated by the operating unit.

18. The switching display method of claim 15, further providing an operating voltage to the electronic device by a power source, and controlling the first display unit to stop displaying, when the operating voltage is less than a first predetermined value.

19. The switching display method of claim 18, further comprising defining a second predetermined value to determine if images to be displayed are moving images.

20. The switching display method of claim 19, further comprising increasing the second predetermined value when the operating voltage output is less than the first predetermined value.
